(19) United States
(12) Patent Application Publication
(10) Pub. No.: US 2013/0158887 A1
(43) Pub. Date: Jun. 20, 2013

(54) COLLABORATIVE ENVIRONMENT/EXPERIMENT MONITORING DEVICE AND SYSTEM

(71) Applicant: Dov BRUKER, Ra'anana (IL)

(72) Inventor: Dov BRUKER, Ra'anana (IL)

(73) Assignee: GLOBISENS LTD., Ra'anana (IL)

(21) Appl. No.: 13/331,508

(22) Filed: Dec. 20, 2011

(51) Int. Cl. G06F 19/00

(52) U.S. Cl. 702/22; 702/127

(57) ABSTRACT

A sensor-selectable environment/experiment monitoring device including at least one selectable environment/experiment monitoring sensor operative to collect environment/experimental data and a sensor selector cover operable to provide access to at least a first one of the at least one selectable environment/experiment monitoring sensor and to simultaneously prevent access to at least a second one of the at least one selectable environment/experiment monitoring sensor.

### FIELD OF THE INVENTION

The present invention relates to collaborative environment/experiment monitoring devices and systems.

### BACKGROUND OF THE INVENTION

The following patent publications are believed to represent the current state of the art:
U.S. Pat. No. 5,526,287; and
U.S. Published Patent Application No. 2010/0285436.

### SUMMARY OF THE INVENTION

The present invention provides collaborative environment/experiment monitoring devices and systems.

There is thus provided in accordance with a preferred embodiment of the present invention a sensor-selectable environment/experiment monitoring device including at least one selectable environment/experiment monitoring sensor operative to collect environment/experimental data and a sensor selector cover operable to provide access to at least a first one of the at least one selectable environment/experiment monitoring sensor and to simultaneously prevent access to at least a second one of the at least one selectable environment/experiment monitoring sensor.

Preferably, the at least one selectable environment/experiment monitoring sensor is operative to collect environment/experimental data pertaining to at least one of temperature, air quality, chemical composition, light intensity and barometric pressure. Preferably, the device also includes GPS locator functionality. Preferably, the device is also operative to associate the environment/experimental data with corresponding geographic coordinates provided by the GPS locator functionality.

Preferably, the at least one selectable environment/experiment monitoring sensor is formed on an outer circumferential surface of the device. Preferably, the device also includes an extendible stand formed on a bottom surface thereof, the stand operable for generally semi-vertical mounting of the device on a horizontal surface.

In accordance with a preferred embodiment of the present invention the device also includes sensor activation buttons operable for activating corresponding ones of the at least one selectable environment/experiment monitoring sensor. Preferably, each of the at least one selectable environment/experiment monitoring sensor is generally aligned with a corresponding one of the activation buttons. Preferably, the device also includes a display operable for displaying sensor readings of activated ones of the at least one selectable environment/experiment monitoring sensor.

Preferably, the sensor selector cover is rotatably mounted on the outer circumferential surface of the device. Preferably, the sensor selector cover includes a generally rectangular aperture formed therewithin, whereby rotating the sensor selector cover relative to the device is operative to align the aperture with at least a first one of the at least one selectable environment/experiment monitoring sensor thereby providing access thereto and thereby simultaneously preventing access to at least a second one of the at least one selectable environment/experiment monitoring sensor.

In accordance with a preferred embodiment of the present invention the device also includes at least one selectable environment/experiment monitoring sensor socket, the socket enabling connection of an external environment/experiment monitoring sensor thereto. Preferably, rotating the sensor selector cover relative to the device is also operative to align the aperture with at least a first one of the at least one selectable environment/experiment monitoring sensor socket thereby providing access thereto and thereby simultaneously preventing access to at least one of one of the at least one selectable environment/experiment monitoring sensor and a second one of the at least one selectable environment/experiment monitoring sensor socket. Additionally, rotating the sensor selector cover relative to the device is also operative to align the aperture with at least a first one of the at least one selectable environment/experiment monitoring sensor thereby providing access thereto and thereby simultaneously preventing access to at least one of a second one of the at least one selectable environment/experiment monitoring sensor and one of the at least one selectable environment/experiment monitoring sensor socket.

Preferably, the at least one selectable environment/experiment monitoring sensor socket is formed on an outer circumferential surface of the device. Preferably, the device also includes sensor activation buttons operable for activating corresponding ones of the external environment/experiment monitoring sensors connected to the at least one selectable environment/experiment monitoring sensor socket. Preferably, each of the at least one selectable environment/experiment monitoring sensor socket is generally aligned with a corresponding one of the activation buttons. Preferably, the display is also operable for displaying sensor readings of activated ones of the external environment/experiment monitoring sensors connected to the at least one selectable environment/experiment monitoring sensor socket.

There is also provided in accordance with another preferred embodiment of the present invention a collaborative environment/experiment monitoring system including an environment/experiment data aggregating subsystem and a plurality of portable sensor-selectable environment/experiment monitoring devices communicating with the environment/experiment data aggregating subsystem, each of the devices including at least one selectable environment/experiment monitoring sensor operative to collect environment/experimental data and wherein at least some of the plurality of portable sensor-selectable environment/experiment monitoring devices comprise GPS locator functionality.

Preferably, the at least one selectable environment/experiment monitoring sensor is operative to collect environment/experimental data pertaining to at least one of temperature, air quality, chemical composition, light intensity and barometric pressure. Preferably, the system also includes a sensor selector cover operable to provide access to at least a first one of the at least one selectable environment/experiment monitoring sensor and to simultaneously prevent access to at least a second one of the at least one selectable environment/experiment monitoring sensor.

Preferably, the at least some of the devices including GPS locator functionality are operative to associate the environment/experimental data with corresponding geographic coordinates provided by the GPS locator functionality.

Preferably, the environment/experiment data aggregating subsystem resides on a computer. Preferably, the environment/experiment data aggregating subsystem is operative to aggregate the environment/experimental data from the plurality of portable sensor-selectable environment/experiment monitoring devices communicating therewith.

In accordance with a preferred embodiment of the present invention the environment/experiment data aggregating subsystem is operative to aggregate the environment/experimental data from the plurality of portable sensor-selectable environment/experiment monitoring devices generally concurrently with the collection of the environment/experimental data by the at least one selectable environment/experiment monitoring sensor. Alternatively, the environment/experiment data aggregating subsystem is operative to aggregate the environment/experimental data from the plurality of portable sensor-selectable environment/experiment monitoring devices non-concurrently with the collection of the environment/experimental data by the at least one selectable environment/experiment monitoring sensor.

Preferably, communication between at least some of the plurality of portable sensor-selectable environment/experiment monitoring devices and the computer is wired. Additionally or alternatively, communication between at least some of the plurality of portable sensor-selectable environment/experiment monitoring devices and the computer is wireless.

Preferably, the computer is connectable to a data projector. Preferably, communication between the computer and the data projector is wired. Additionally or alternatively, communication between the computer and the data projector is wireless.

In accordance with a preferred embodiment of the present invention the computer is operative to employ the environment/experimental data aggregated from the plurality of portable sensor-selectable environment/experiment monitoring devices to perform a comparative analysis of environment/experimental data aggregated from different ones of the devices.

Preferably, the at least one selectable environment/experiment monitoring sensor is formed on an outer circumferential surface of each of the devices. Preferably, each of the devices also includes an extendible stand formed on a bottom surface thereof, the stand operable for generally semi-vertical mounting of the device on a horizontal surface. Preferably, each of the devices also includes sensor activation buttons operable for activating corresponding ones of the at least one selectable environment/experiment monitoring sensor. Preferably, each of the at least one selectable environment/experiment monitoring sensor is generally aligned with a corresponding one of the activation buttons. Preferably, each of the devices also includes a display operable for displaying sensor readings of activated ones of the at least one selectable environment/experiment monitoring sensor.

In accordance with a preferred embodiment of the present invention the sensor selector cover is rotatably mounted on the outer circumferential surface of the device. Preferably, the sensor selector cover includes a generally rectangular aperture formed therewithin, whereby rotating the sensor selector cover relative to the device is operative to align the aperture with at least a first one of the at least one selectable environment/experiment monitoring sensor thereby providing access thereto and thereby simultaneously preventing access to at least a second one of the at least one selectable environment/experiment monitoring sensor.

In accordance with a preferred embodiment of the present invention each of the devices also includes at least one selectable environment/experiment monitoring sensor socket, the socket enabling connection of an external environment/experiment monitoring sensor thereto. Preferably, rotating the sensor selector cover relative to the device is also operative to align the aperture with at least a first one of the at least one selectable environment/experiment monitoring sensor socket thereby providing access thereto and thereby simultaneously preventing access to at least one of one of the at least one selectable environment/experiment monitoring sensor and a second one of the at least one selectable environment/experiment monitoring sensor socket. Alternatively, rotating the sensor selector cover relative to the device is also operative to align the aperture with at least a first one of the at least one selectable environment/experiment monitoring sensor thereby providing access thereto and thereby simultaneously preventing access to at least one of a second one of the at least one selectable environment/experiment monitoring sensor and one of the at least one selectable environment/experiment monitoring sensor socket.

Preferably, the at least one selectable environment/experiment monitoring sensor socket is formed on an outer circumferential surface of each of the devices. Preferably, each of the devices also includes sensor activation buttons operable for activating corresponding ones of the external environment/experiment monitoring sensors connected to the at least one selectable environment/experiment monitoring sensor socket. Preferably, each of the at least one selectable environment/experiment monitoring sensor socket is generally aligned with a corresponding one of the activation buttons. Preferably, the display is also operable for displaying sensor readings of activated ones of the external environment/experiment monitoring sensors connected to the at least one selectable environment/experiment monitoring sensor socket.

### BRIEF DESCRIPTION OF THE DRAWINGS

The present invention will be understood and appreciated more fully from the following detailed description, taken in conjunction with the drawings in which:

FIG. 1 is a simplified pictorial illustration of the use of a collaborative environment/experiment monitoring system, constructed and operative in accordance with a preferred embodiment of the present invention;

FIGS. 2A and 2B are simplified exploded view illustrations of a sensor-selectable environment/experiment monitoring device which is part of the collaborative environment/experiment monitoring system of FIG. 1;

FIGS. 3A and 3B are simplified pictorial illustrations of examples of the selection of integral sensors and sensor connection sockets which are part of the device of FIGS. 2A & 2B; and

FIGS. 4A, 4B and 4C are simplified pictorial illustrations of an example of the use of an external sensor connection socket which is part of the device of FIGS. 2A-3B.

### DETAILED DESCRIPTION OF PREFERRED EMBODIMENTS

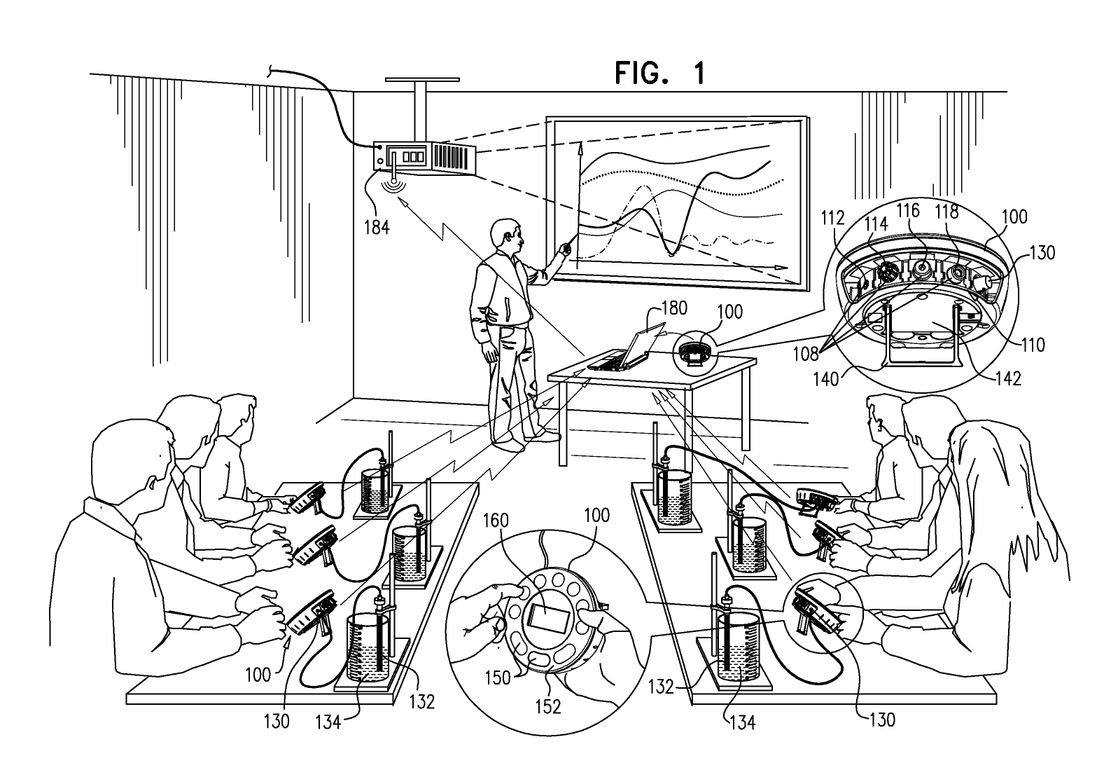

Reference is now made to FIG. 1, which is a simplified pictorial illustration of the use of a collaborative environment/experiment monitoring system, constructed and operative in accordance with a preferred embodiment of the present invention. The collaborative environment/experiment monitoring system of FIG. 1 preferably includes an environment/experiment data aggregating subsystem and a plurality of portable sensor-selectable environment/experiment monitoring devices communicating with the environment/experiment data aggregating subsystem. Preferably, each of the devices includes at least one selectable environment/experiment monitoring sensor operative to collect environment/experimental data and a sensor selector cover operable to provide access to at least a first one of the at least one selectable environment/experiment monitoring sensor and to simultaneously prevent access to at least a second one of the at least one selectable environment/experiment monitoring sensor.

As shown in FIG. 1, a plurality of portable sensor-selectable environment/experiment monitoring devices 100 are employed by a group of students. Monitoring devices 100 are preferably operable for collecting and monitoring environment/experimental data which is typically analyzed as part of scientific observation. Such data may be, for example, measurements of temperature, air quality, chemical composition, light intensity and barometric pressure.

As further shown in FIG. 1, sensor-selectable environment/experiment monitoring devices 100 preferably include a multiplicity of selectable environment/experiment integral monitoring sensors 108 formed on an outer circumferential surface 110 of devices 100. In the devices 100 of FIG. 1, integral sensors 108 include a temperature sensor 112, a relative humidity sensor 114, an infrared temperature sensor 116 and a carbon-monoxide sensor 118. It is appreciated that in other embodiments of the present invention, sensors 108 may also include, for example, any of a pH level detector, a colorimeter, a turbidity level analyzer, a UV detector, a barometer, an air pressure analyzer, electric current and voltage meters, a light detector, and a microphone\sound level analyzer.

External sensor connection sockets 130 are also preferably provided on outer circumferential surface 110 of devices 100, interstitial to integral sensors 108, which sockets are operable for connecting external sensors 132 to monitoring devices 100. External sensors 132 are useful for collecting and monitoring data in environment/experiments which are not accessible to integral sensors of 108, such as environment/experiments which require immersion of a sensor in a liquid in order to measure the temperature or analyze the chemical composition thereof. Additionally, external sensor connection sockets 130 enable connection of additional sensors which are not integrally provided with device 100.

As shown in FIG. 1, external sensors 132 operative to analyze the chemical composition of liquids are connected to devices 100 and are immersed in a corresponding number of beakers 134 containing various liquids to be analyzed.

An extendible stand 140 is preferably provided on a bottom surface 142 of devices 100 for generally semi-vertical mounting of monitoring device 100 on a horizontal surface.

Sensor activation buttons 150 are preferably provided on a top surface 152 of devices 100 for activating corresponding ones of integral sensors 108 and external sensors 132 connected to external sensor connection sockets 130. It is appreciated that each of activation buttons 150 is preferably generally aligned with a corresponding one of integral sensors 108 and external sensor connection sockets 130.

It is appreciated that upon activation, data collected by sensors 108 and 132 is preferably stored in devices 100. A display 160 is preferably formed in top surface 152 for displaying sensor readings of activated ones of integral sensors 108 and activated ones of external sensors 132 connected to external sensor connection sockets 130.

Preferably, devices 100 also include locator functionality, such as GPS locator functionality, which is operative to associate geographical coordinates with the collected data. Display 160 is also preferably operative to display the geographical coordinates associated with the sensor readings.

It is a particular feature of the present invention that, as seen in FIG. 1, devices 100 are connectable to a computer 180 which preferably aggregates environment/experimental data collected by devices 100. The data may be aggregated by computer 180 generally concurrently or non-concurrently with the collection of the data by devices 100 from the environment/experiment. In the example of FIG. 1 it is shown that data is aggregated by computer 180 generally concurrently with the collection of the data by devices 100. It is appreciated that communication between devices 100 and computer 180 may be either wired or wireless.

As further shown in FIG. 1, an instructor preferably displays the aggregated data by computer 180 from devices 100 by employing a data projector 184 which is connected to computer 180. It is appreciated that communication between computer 180 and data projector 184 may be either wired or wireless.

It is another particular feature of the present invention that the instructor may use the data aggregated by computer 180 from devices 100 to perform a comparative analysis of data aggregated from different ones of devices 100. The comparative analysis may include, for example, mutual overlay and comparison of data trends and averages of collected data parameters.

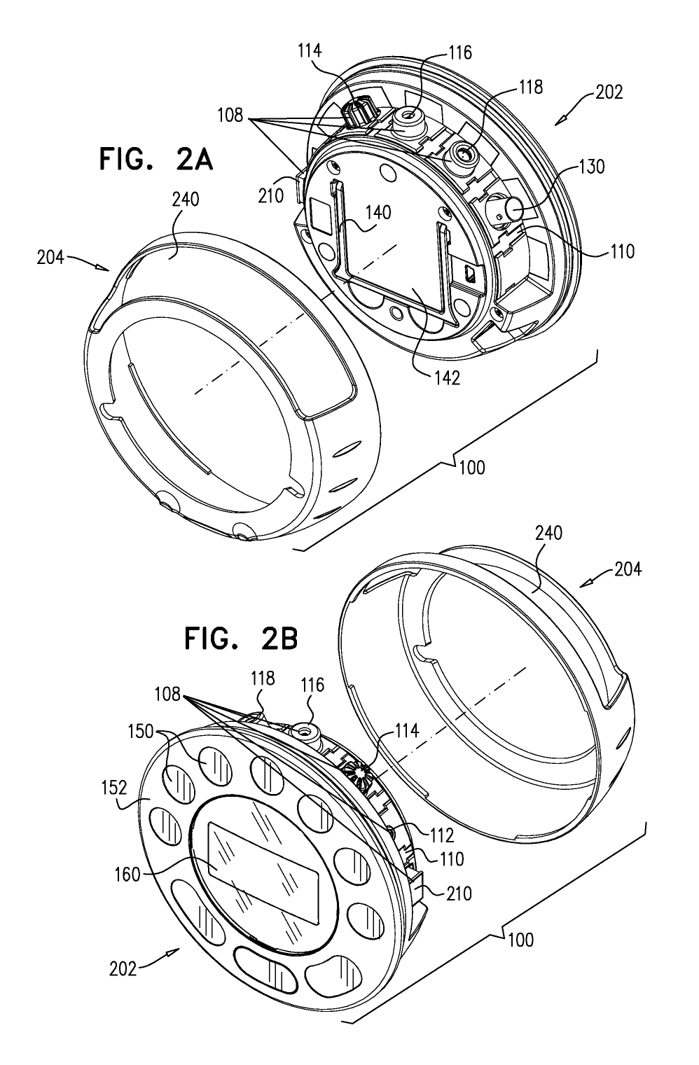

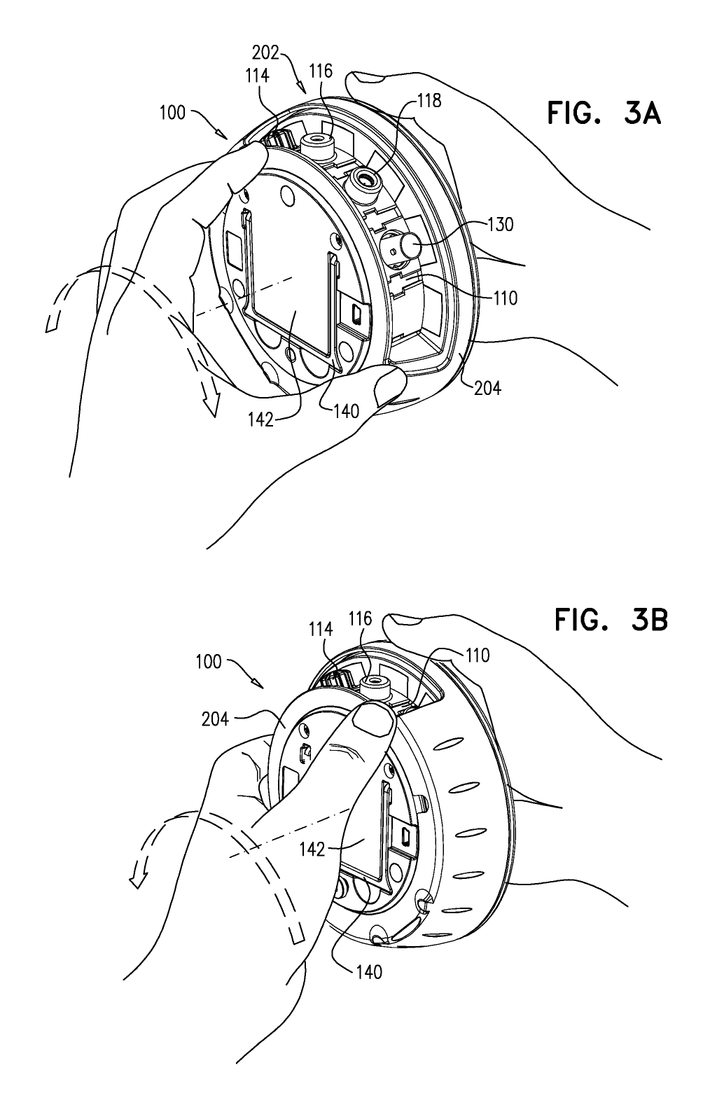

Reference is now made to FIGS. 2A and 2B, which are simplified exploded view illustrations of a sensor-selectable environment/experiment monitoring device which is part of the collaborative environment/experiment monitoring system of FIG. 1, and to FIGS. 3A and 3B, which are simplified pictorial illustrations of examples of the selection of integral sensors and sensor connection sockets which are part of the device of FIGS. 2A & 2B.

The sensor-selectable environment/experiment monitoring device of FIGS. 2A-3B preferably includes at least one selectable environment/experiment monitoring sensor operative to collect environment/experimental data and a sensor selector cover operable to provide access to at least a first one of the at least one selectable environment/experiment monitoring sensor and to simultaneously prevent access to at least a second one of the at least one selectable environment/experiment monitoring sensor.

As shown in FIGS. 2A & 2B, sensor-selectable environment/experiment monitoring device 100 includes a generally flat disk-shaped main portion 202 and a corresponding generally hollow flat disk-shaped sensor selector cover 204. Main portion 202 comprises outer circumferential surface 110 upon which are mounted integral sensors 108, preferably temperature sensor 112, relative humidity sensor 114, infrared temperature sensor 116, a carbon-monoxide sensor 118, pH level detector 120 and a colorimeter 210. One external sensor connection socket 130 is also shown mounted on outer circumferential surface 110.

As described hereinabove, extendible stand 140 is preferably provided on bottom surface 142 of device 100 for generally semi-vertical mounting of monitoring device 100 on a horizontal surface. Sensor activation buttons 150 are preferably provided on top surface 152 of device 100 for activating corresponding ones of integral sensors 108 and external sensors connected to external sensor connection sockets 130. It is appreciated that upon activation of a sensor, data collected by sensors 108 and 132 is preferably stored in device 100. Display 160 is preferably formed in top surface 152 for displaying sensor readings of activated ones of integral sensors 108 and external sensors connected to external sensor connection sockets 130.

As also described hereinabove, devices 100 also preferably include locator functionality, such as GPS locator functionality, which is operative to associate geographical coordinates with the collected data. Display 160 is preferably operative to display the geographical coordinates associated with the sensor readings.

Sensor selector cover 204 is preferably rotatably mounted on outer circumferential surface 110 of main portion 202. A generally rectangular aperture 240 preferably formed in cover 204 provides access to some of integral sensors 108 and sensor connection sockets 130. As shown in FIGS. 3A & 3B, rotation of selector cover 204 relative to main body 202 is operative to provide access to some of integral sensors 108 and sockets 130 via aperture 240 while preventing access to others of integral sensors 108 and sockets 130. It is appreciated that the arrangement by which at any given time cover 204 provides access to only selected ones of sensors 108 and sockets 130 is operative to protect unselected ones of sensors 108 and sockets 130 to which access is not needed at the given time.

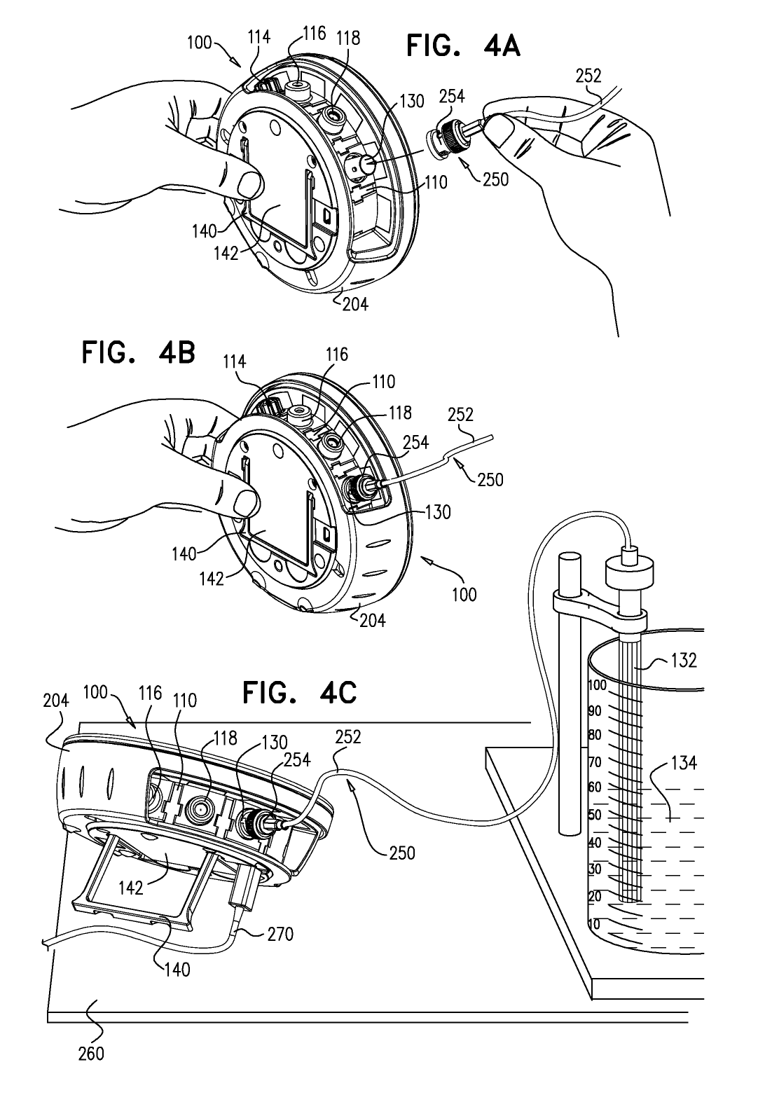

Reference is now made to FIGS. 4A, 4B and 4C, which are simplified pictorial illustrations of an example of the use of an external sensor connection socket which is part of the device of FIGS. 2A-3B. As shown in FIGS. 4A-4C, a user of monitoring device 100 employs an external sensor connecting cable 250 to connect external sensor 132 to monitoring device 100. As shown in FIG. 4C, external sensor 132 is immersed in beaker 134 which is filled with a liquid being analyzed by external sensor 132. External sensor 132 may be operative, for example, to analyze the chemical composition of the liquid of beaker 134.

External sensor connecting cable 250 preferably includes a cable element 252 and a connector element 254. As shown in FIGS. 4A & 4B, the user connects connector element 254 to one of external sensor connection sockets 130 provided on outer circumferential surface 110 of main portion 202 of device 100. It is appreciated that external sensor connection sockets 130 preferably include sockets provided to facilitate connection of a variety of standard commercially available sensors and connector elements.

As shown in particular in FIG. 4C, extendible stand 140 is shown in an extended position, and is employed to mount device 100 generally semi-vertically on a horizontal surface 260. As also shown in FIG. 4C, a USB cable 270 may be provided for connecting device 100 to an external computing device, such as computer 180 of FIG. 1.

It will be appreciated by persons skilled in the art that the present invention is not limited by what has been particularly shown and described hereinabove. Rather, the invention also includes various combinations and subcombinations of the features described hereinabove as well as modifications and variations thereof, which would occur to persons skilled in the art upon reading the foregoing and which are not in the prior art.

1. A sensor-selectable environment/experiment monitoring device comprising:
at least one selectable environment/experiment monitoring sensor operative to collect environment/experimental data; and
a sensor selector cover operable to provide access to at least a first one of said at least one selectable environment/experiment monitoring sensor and to simultaneously prevent access to at least a second one of said at least one selectable environment/experiment monitoring sensor.

2. A sensor-selectable environment/experiment monitoring device according to claim 1 and wherein said at least one selectable environment/experiment monitoring sensor is operative to collect environment/experimental data pertaining to at least one of temperature, air quality, chemical composition, light intensity and barometric pressure.

3. A sensor-selectable environment/experiment monitoring device according to claim 2 and also comprising GPS locator functionality.

4. A sensor-selectable environment/experiment monitoring device according to claim 3 and wherein said device is also operative to associate said environment/experimental data with corresponding geographic coordinates provided by said GPS locator functionality.

5. A sensor-selectable environment/experiment monitoring device according to claim 1 and wherein said at least one selectable environment/experiment monitoring sensor is formed on an outer circumferential surface of said device.

6. A sensor-selectable environment/experiment monitoring device according to claim 1 and also comprising an extendible stand formed on a bottom surface thereof, said stand operable for generally semi-vertical mounting of said device on a horizontal surface.

7. A sensor-selectable environment/experiment monitoring device according to claim 1 and also comprising sensor activation buttons operable for activating corresponding ones of said at least one selectable environment/experiment monitoring sensor.

8. A sensor-selectable environment/experiment monitoring device according to claim 7 and wherein each of said at least one selectable environment/experiment monitoring sensor is generally aligned with a corresponding one of said activation buttons.

9. A sensor-selectable environment/experiment monitoring device according to claim 5 and also comprising a display operable for displaying sensor readings of activated ones of said at least one selectable environment/experiment monitoring sensor.

10. A sensor-selectable environment/experiment monitoring device according to claim 9 and wherein said sensor selector cover is rotatably mounted on said outer circumferential surface of said device.

11. A sensor-selectable environment/experiment monitoring device according to claim 10 and wherein said sensor selector cover comprises a generally rectangular aperture formed therewithin, whereby rotating said sensor selector cover relative to said device is operative to align said aperture with at least a first one of said at least one selectable environment/experiment monitoring sensor thereby providing access thereto and thereby simultaneously preventing access to at least a second one of said at least one selectable environment/experiment monitoring sensor.

12. A sensor-selectable environment/experiment monitoring device according to claim 11 and also comprising at least one selectable environment/experiment monitoring sensor socket, said socket enabling connection of an external environment/experiment monitoring sensor thereto.

13. A sensor-selectable environment/experiment monitoring device according to claim 12 and wherein rotating said sensor selector cover relative to said device is also operative to align said aperture with at least a first one of said at least one selectable environment/experiment monitoring sensor socket thereby providing access thereto and thereby simultaneously preventing access to at least one of:
one of said at least one selectable environment/experiment monitoring sensor; and
a second one of said at least one selectable environment/experiment monitoring sensor socket.

14. A sensor-selectable environment/experiment monitoring device according to claim 12 and wherein rotating said sensor selector cover relative to said device is also operative to align said aperture with at least a first one of said at least one selectable environment/experiment monitoring sensor thereby providing access thereto and thereby simultaneously preventing access to at least one of:
a second one of said at least one selectable environment/experiment monitoring sensor; and
one of said at least one selectable environment/experiment monitoring sensor socket.

15. A sensor-selectable environment/experiment monitoring device according to claim 12 and wherein said at least one selectable environment/experiment monitoring sensor socket is formed on an outer circumferential surface of said device.

16. A sensor-selectable environment/experiment monitoring device according to claim 12 and also comprising sensor activation buttons operable for activating corresponding ones of said external environment/experiment monitoring sensors connected to said at least one selectable environment/experiment monitoring sensor socket.

17. A sensor-selectable environment/experiment monitoring device according to claim 16 and wherein each of said at least one selectable environment/experiment monitoring sensor socket is generally aligned with a corresponding one of said activation buttons.

18. A sensor-selectable environment/experiment monitoring device according to claim 17 and wherein said display is also operable for displaying sensor readings of activated ones of said external environment/experiment monitoring sensors connected to said at least one selectable environment/experiment monitoring sensor socket.

19. A collaborative environment/experiment monitoring system comprising:
an environment/experiment data aggregating subsystem; and
a plurality of portable sensor-selectable environment/experiment monitoring devices communicating with said environment/experiment data aggregating subsystem, each of said devices comprising:
at least one selectable environment/experiment monitoring sensor operative to collect environment/experimental data, and wherein at least some of said plurality of portable sensor-selectable environment/experiment monitoring devices comprise GPS locator functionality.

20. A collaborative environment/experiment monitoring system according to claim 19 and wherein said at least one selectable environment/experiment monitoring sensor is operative to collect environment/experimental data pertaining to at least one of temperature, air quality, chemical composition, light intensity and barometric pressure.

21. A collaborative environment/experiment monitoring system according to claim 20 and also comprising a sensor selector cover operable to provide access to at least a first one of said at least one selectable environment/experiment monitoring sensor and to simultaneously prevent access to at least a second one of said at least one selectable environment/experiment monitoring sensor.

22. A collaborative environment/experiment monitoring system according to claim 21 and wherein said at least some of said devices comprising GPS locator functionality are operative to associate said environment/experimental data with corresponding geographic coordinates provided by said GPS locator functionality.

23. A collaborative environment/experiment monitoring system according to claim 19 and wherein said environment/experiment data aggregating subsystem resides on a computer.

24. A collaborative environment/experiment monitoring system according to claim 19 and wherein said environment/experiment data aggregating subsystem is operative to aggregate said environment/experimental data from said plurality of portable sensor-selectable environment/experiment monitoring devices communicating therewith.

25. A collaborative environment/experiment monitoring system according to claim 19 and wherein said environment/experiment data aggregating subsystem is operative to aggregate said environment/experimental data from said plurality of portable sensor-selectable environment/experiment monitoring devices generally concurrently with said collection of said environment/experimental data by said at least one selectable environment/experiment monitoring sensor.

26. A collaborative environment/experiment monitoring system according to claim 19 and wherein said environment/experiment data aggregating subsystem is operative to aggregate said environment/experimental data from said plurality of portable sensor-selectable environment/experiment monitoring devices non-concurrently with said collection of said environment/experimental data by said at least one selectable environment/experiment monitoring sensor.

27. A collaborative environment/experiment monitoring system according to claim 23 and wherein communication between at least some of said plurality of portable sensor-selectable environment/experiment monitoring devices and said computer is wired.

28. A collaborative environment/experiment monitoring system according to claim 23 and wherein communication between at least some of said plurality of portable sensor-selectable environment/experiment monitoring devices and said computer is wireless.

29. A collaborative environment/experiment monitoring system according to claim 23 and wherein said computer is connectable to a data projector.

30. A collaborative environment/experiment monitoring system according to claim 29 and wherein communication between said computer and said data projector is wired.

31. A collaborative environment/experiment monitoring system according to claim 29 and wherein communication between said computer and said data projector is wireless.

32. A collaborative environment/experiment monitoring system according to claim 23 and wherein said computer is operative to employ said environment/experimental data aggregated from said plurality of portable sensor-selectable environment/experiment monitoring devices to perform a comparative analysis of environment/experimental data aggregated from different ones of said devices.

33. A collaborative environment/experiment monitoring system according to claim 19 and wherein said at least one selectable environment/experiment monitoring sensor is formed on an outer circumferential surface of each of said devices.

34. A collaborative environment/experiment monitoring system according to claim 19 and wherein each of said devices also comprises an extendible stand formed on a bottom surface thereof, said stand operable for generally semi-vertical mounting of said device on a horizontal surface.

35. A collaborative environment/experiment monitoring system according to claim 19 and wherein each of said devices also comprises sensor activation buttons operable for activating corresponding ones of said at least one selectable environment/experiment monitoring sensor.

36. A collaborative environment/experiment monitoring system according to claim 35 and wherein each of said at least one selectable environment/experiment monitoring sensor is generally aligned with a corresponding one of said activation buttons.

37. A collaborative environment/experiment monitoring system according to claim 33 and wherein each of said devices also comprises a display operable for displaying sensor readings of activated ones of said at least one selectable environment/experiment monitoring sensor.

38. A collaborative environment/experiment monitoring system according to claim 37 and wherein said sensor selector cover is rotatably mounted on said outer circumferential surface of said device.

39. A collaborative environment/experiment monitoring system according to claim 38 and wherein said sensor selector cover comprises a generally rectangular aperture formed therewithin, whereby rotating said sensor selector cover relative to said device is operative to align said aperture with at least a first one of said at least one selectable environment/experiment monitoring sensor thereby providing access thereto and thereby simultaneously preventing access to at least a second one of said at least one selectable environment/experiment monitoring sensor.

40. A collaborative environment/experiment monitoring system according to claim 39 and wherein each of said devices also comprises at least one selectable environment/experiment monitoring sensor socket, said socket enabling connection of an external environment/experiment monitoring sensor thereto.

41. A collaborative environment/experiment monitoring system according to claim 40 and wherein rotating said sensor selector cover relative to said device is also operative to align said aperture with at least a first one of said at least one selectable environment/experiment monitoring sensor socket thereby providing access thereto and thereby simultaneously preventing access to at least one of:
one of said at least one selectable environment/experiment monitoring sensor; and
a second one of said at least one selectable environment/experiment monitoring sensor socket.

42. A collaborative environment/experiment monitoring system according to claim 40 and wherein rotating said sensor selector cover relative to said device is also operative to align said aperture with at least a first one of said at least one selectable environment/experiment monitoring sensor thereby providing access thereto and thereby simultaneously preventing access to at least one of:
a second one of said at least one selectable environment/experiment monitoring sensor; and
one of said at least one selectable environment/experiment monitoring sensor socket.

43. A collaborative environment/experiment monitoring system according to claim 40 and wherein said at least one selectable environment/experiment monitoring sensor socket is formed on an outer circumferential surface of each of said devices.

44. A collaborative environment/experiment monitoring system according to claim 40 and wherein each of said devices also comprises sensor activation buttons operable for activating corresponding ones of said external environment/experiment monitoring sensors connected to said at least one selectable environment/experiment monitoring sensor socket.

45. A collaborative environment/experiment monitoring system according to claim 44 and wherein each of said at least one selectable environment/experiment monitoring sensor socket is generally aligned with a corresponding one of said activation buttons.

46. A collaborative environment/experiment monitoring system according to claim 44 and wherein said display is also operable for displaying sensor readings of activated ones of said external environment/experiment monitoring sensors connected to said at least one selectable environment/experiment monitoring sensor socket.
